(19) United States
(12) Patent Application Publication
(10) Pub. No.: US 2009/0154397 A1
(43) Pub. Date: Jun. 18, 2009

(54) SYSTEM AND METHOD FOR PROVIDING QUALITY OF SERVICE ENABLERS FOR THIRD PARTY APPLICATIONS

(75) Inventor: Haseeb Akhtar, Garland, TX (US)

Correspondence Address: HAYNES AND BOONE, LLP;IP Section, 2323 Victory Avenue, Suite 700, Dallas, TX, 75219, US

(73) Assignee: NORTEL NETWORKS LIMITED, St. Laurent (CA)

(21) Appl. No.: 12/327,607

(22) Filed: Dec. 3, 2008

Related U.S. Application Data
(60) Provisional application No. 61/014,163, filed on Dec. 17, 2007.

(51) Int. Cl. H04W 28/24

(52) U.S. Cl. 370/328

(57) ABSTRACT

System and method for providing quality of service enablers for third party applications are described. In one embodiment, the method comprises user equipment (“UE”) establishing a communications session with a third party application server hosting a selected third party application and receiving from the third party application server QoS information comprising at least one of a plurality of QoS attributes and configuring a QoS of a radio access network (“RAN”) in accordance with the received QoS information. The method further comprises activating the RAN QoS for the selected application; and establishing an application session with the third party application server via the RAN.

### CROSS-REFERENCE TO RELATED APPLICATIONS

The present application claims the benefit of U.S. Provisional Patent Application Ser. No. 61/014,163 filed on Dec. 17, 2007, entitled QoS ENABLERS FOR 3RD PARTY APPLICATIONS.

### BACKGROUND

The embodiments described herein relate generally to provision of third party applications, services, and content (hereinafter collectively referred to as “third party applications”) via both wireline and wireless networks and, more particularly, to providing quality of service (“QoS”) enablers for such third party applications.

QoS over wireless networks is a must for effective delivery of delay sensitive applications, including, but not limited to, push-to-talk (“PTT”), voice over IP (“VoIP”), and mobile video, to name a few. It is well-known that such applications require better than best effort deliver to achieve a satisfactory quality of experience for end users.

Third party, or “over-the-top,” applications offer new revenue opportunities for carriers (both wireline and wireless) and the third party application providers. In particular, provision of such applications over wireline/wireless networks offers third party application providers the opportunity to reach additional end-user customers while offering carriers (wireline and wireless) the opportunity to charge the application providers and/or their customers for use of the network.

However, there currently exists no functionality for guaranteeing a particular level of QoS with respect to third party application services provided over a wireline/wireless network.

### SUMMARY

One embodiment is a method of providing quality of service (“QoS”) enablers for third party applications provided over a carrier (wireline and wireless) network. The method comprises user equipment (“UE”) establishing a communications session with a third party application server hosting a selected third party application and receiving from the third party application server QoS information comprising at least one of a plurality of QoS attributes and configuring a QoS of a radio access network (“RAN”) in accordance with the received QoS information. The method further comprises activating the RAN QoS for the selected application; and establishing an application session with the third party application server via the RAN.

Another embodiment is a method of providing quality of service (“QoS”) enablers for third party applications provided over a wireless carrier network. The method comprises user equipment (“UE”) registering with a proxy application server (“PAS”) in accordance with a first protocol; the UE obtaining a uniform resource identifier (“URI”) of the PAS; and the UE establishing a communications session with the PAS using the received URI of the PAS and selecting an application hosted by a third party application server. The method further comprises the PAS retrieving from the third party application server QoS information for the selected application, the QoS information comprising at least one of a plurality of QoS attributes; allocating the appropriate QoS resources in both CN and RAN while communicating the QoS information to the UE; and the UE establishing an application session with the third party application server via a radio access network (“RAN”) with the appropriate QoS for this specific application.

Yet another embodiment is a method of providing quality of service (“QoS”) enablers for third party applications provided over a wireless carrier network, the method comprising user equipment (“UE”) establishing a communications session with a third party application server hosting a selected third party application. The method further comprises the 3^{rd} party application server communicating the QoS information to a core network (“CN”) component—such as policy rules and charging function (“PCRF”)—and the PCRF in turn then informing the UE via other CN and RAN components while allocating associated QoS resources required for this specific session, the QoS information comprising at least one of a plurality of QoS attributes. The method further comprises the UE establishing an application session with the third party application server via a radio access network (“RAN”) with the appropriate QoS for this specific application.

### DESCRIPTION OF THE DRAWINGS

FIG. 1 illustrates a wireless and wireline network in accordance with one embodiment.

FIG. 2 illustrates network interfaces that may be advantageously deployed within the network of FIG. 1.

FIGS. 3A and 3B collectively illustrate a first exemplary call flow in accordance with one embodiment using the network of FIG. 1.

FIG. 4 illustrates a second exemplary call flow in accordance with one embodiment using the network of FIG. 1.

FIGS. 5A and 5B collectively illustrate a third exemplary call flow in accordance with one embodiment using the network of FIG. 1.

FIG. 6 illustrates a fourth exemplary call flow in accordance with one embodiment using the network of FIG. 1.

FIG. 7 illustrates a comparison of push and pull models of QoS information delivery using a wireless network such as that illustrated in FIG. 1.

### DETAILED DESCRIPTION

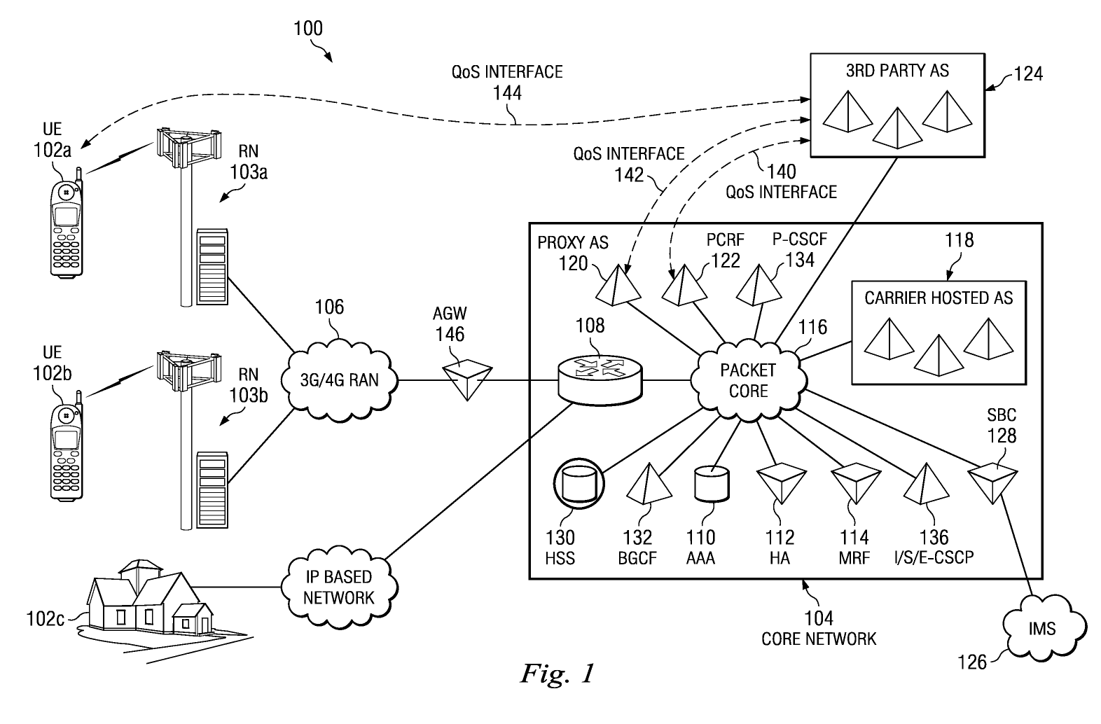

FIG. 1 illustrates a wireless network 100 configured for implementing features of one embodiment. In the illustrated embodiment, a plurality of end user (“UE”) devices, represented in FIG. 1 by wireless UE devices 102a, 102b, and wired UE device 102c, are connected to a core network (“CN”) 104 via radio networks (“RNs”) 103a, 103b, a radio access network (“RAN”) 106, and a router 108. Various elements of the core network 104 may include an authentication, authorization, and accounting function (“AAA”) 110, a home agent (“HA”) 112, and a media resource function (“MRF”) 114.

As shown in FIG. 1, the core network includes a packet core 116 interconnecting a plurality of carrier hosted application servers (“CHASes”) 118, a proxy application server (“PAS”) 120, and a policy and charging rules function (“PCRF”) 122. A plurality of third party application servers (“3PASes) 124 are also connected to the packet core 116 in a conventional manner. In one embodiment, an IP multimedia subsystem (“IMS”) is deployed in connection with the CN 104 and comprises an IMS core 126 connected to the packet core 116 via a session border control (“SBC”) 128 in a conventional manner, as well as a home subscriber server (“HSS”) 130, a border gateway control function (“BGCF”) 132, a proxy-call session control function (“P-CSCF”) 134 and an interrogating/serving/emergency call session control function (“I/S/E-CSCF”) 136.

In accordance with features of one embodiment, new QoS interfaces 140, 142, and 144, are provided for enabling application-specific QoS information between each of the 3PASes 124 and the PCRF 122, between each of the 3PASes and the PAS 120, and between each of the 3PASes 124 and the UEs 102a, 102b, 102c, respectively. The existing interfaces between the P-CSCF 134 and the PCRF 140 (Tx/Rx) and between the PCRF and an application gateway (“AGW”) 146 (Ty/Gx) continue to be leveraged in this embodiment, as will be described.

In one embodiment, attributes for use in providing application-specific QoS information via the QoS interfaces 140, 142, 144, include, but are not limited to, (1) profile ID, (2) type of traffic, (3) maximum rate, (4) minimum rate, (5) bucket size, (6) token rate, (7) emergency service indicator, (8) audio codec type, (9) video codec type, (10) maximum latency, (11) maximum packet loss rate, (12) jitter sensitivity, (13) emergency service indicator, and (14) location coordinates.

The attribute “profile ID” may be a QoS Profile ID as specified by TSB 58-H or may alternatively be any other representation of QoS attributes by hexadecimal and/or decimal numeral. The attribute “type of traffic” may include a description of the behavior of the traffic, such as interactive, streaming, conversational, delay-tolerant data, etc., may characterize the traffic as audio/video combined, audio only, or video only; may characterize the directional aspect of the traffic, such as one way or two way; may indicate whether the traffic is unicast or broadcast, and may characterize the traffic as constant bit rate (“CBR”) or variable bit rate (“VBR”). The “profile ID” may also indicate any of the QoS Class Indicator (“QCI”) values as defined by 3GPP TS 23.203. The attributes “maximum rate” and “minimum rate” respectively indicate the maximum and minimum throughput (e.g., in bits-per-second), respectively, required by the traffic. The attribute “bucket size” indicates maximum and minimum bucket sizes for the traffic, while the attribute “token rate” indicates maximum and minimum token rates for the traffic. The attribute “emergency service indicator” identifies whether the application is to be used in emergency situations and/or by emergency users and also may specify multiple priorities between emergency users. The attribute “audio codec type” identifies the type of audio codec used by the application, such as EVRC, AMR, G7xx, etc. Similarly, the attribute “video codec type” identifies the type of video codec used by the application, such as MPEG-4, H.323, etc., as well as the number of frames per second processable by the codec. Additionally, the “video codec type” describes the size and/or form factor of the screen where the video will be displayed such as quarter common intermediate format (“qcif”) value denoting a specific combination of frames per second (“fps”), lines, pixels etc. parameters.

The attribute “maximum latency” indicates the maximum latency tolerable by the application and may be specified in terms of maximum acceptable end-to-end latency, maximum acceptable latency in the RAN, and maximum acceptable latency in the CN, for example. The attribute “maximum packet loss rate” indicates the maximum acceptable packet loss rate and may be specified as maximum acceptable packet loss rate in the RAN for layer 1, layer 2 and/or layer 3 and maximum acceptable packet loss rate in the CN for layer 1, layer 2 and/or layer 3. The attribute “jitter sensitivity” can be specified as end-to-end jitter sensitivity, jitter sensitivity across the RAN, and/or jitter sensitivity across the CN. The attribute “location coordinates” may provide location information, such as latitude/longitude and/or cell site number, of the UE and/or location information required to deliver the application.

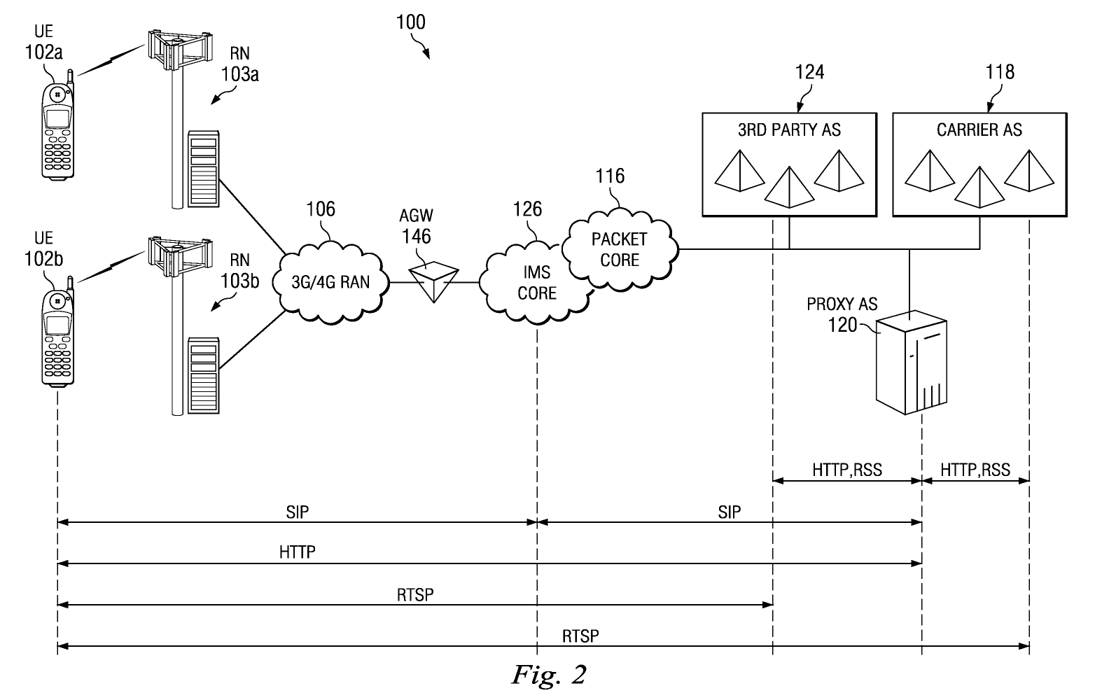

FIG. 2 illustrates network interfaces that may be advantageously deployed within the wireline and/or wireless network 100 (FIG. 1). As shown in FIG. 2, communication between the 3PASes 124 and the PAS 120, as well as between the CASes 118 and the PAS 120 is effected using hypertext transfer protocol (“HTTP”) and/or RDF site summary (“RSS”). Communication between the UEs 102a, 102b, and the IMS core 126/packet core 116, as well as between the PAS 120 and the IMS core 126/packet core 116, is effected using session initiation protocol (“SIP”). Communication between the UEs 102a, 102b, and the PAS 120 is effected using HTTP. Communication between the UEs 102a, 102b, and the CASes 118 is effected using real time streaming protocol (“RTSP”).

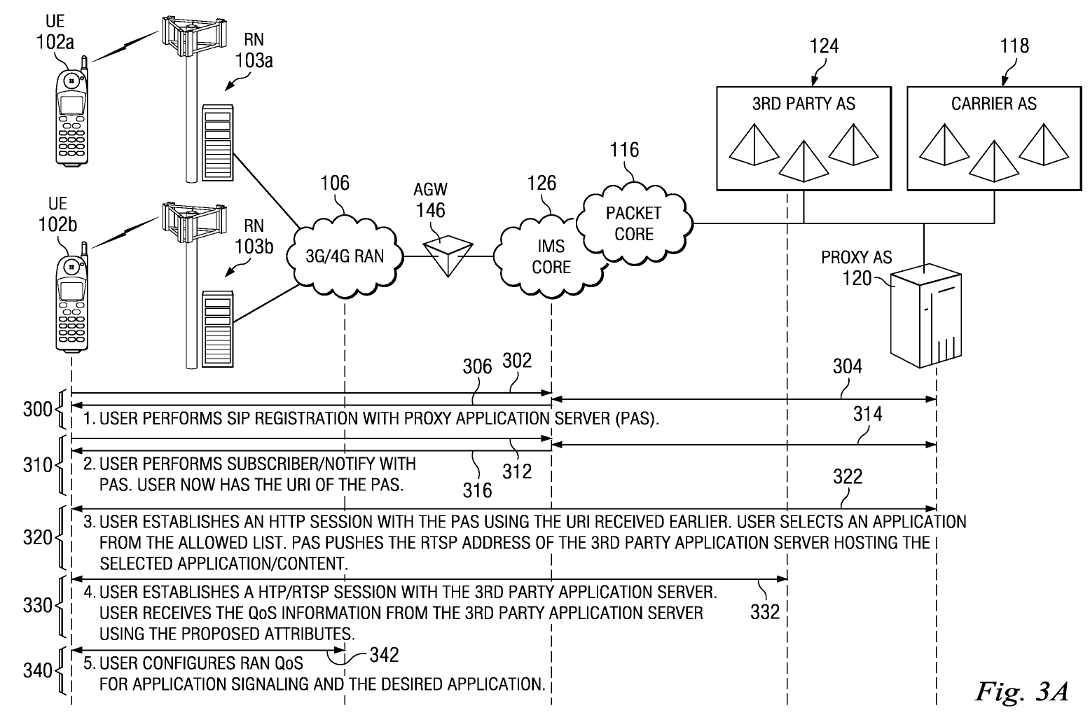

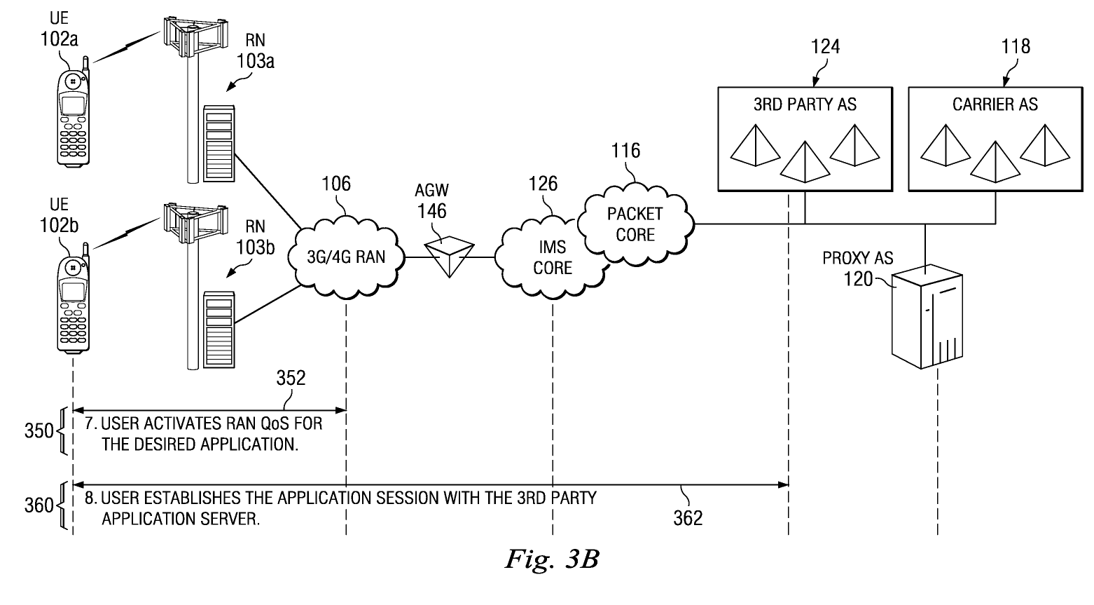

FIG. 3 illustrates a first exemplary call flow implemented using the wireless network 100. In step 300, a user at one of the UEs 102a, 102b, performs an SIP registration with the PAS 120, as represented by arrows 302-306. In step 310, the UE performs a SUBSCRIBER/NOTIFY with the PAS 120, as represented by arrows 312-316. As a result of step 310, the UE has possession of the URI of the PAS 120. In step 320, the UE establishes an HTTP session with the PAS 120 using the URI received during step 310, as represented by an arrow 322. In this step, the UE is authenticated and provided a catalog of applications that the UE is authorized to access and from which the user may select. Once the user selects an application from the catalog, the PAS 120 pushes the address (such as RTSP, URI etc.) of the particular one of the 3PASes 124 hosting the selected application to the UE.

In accordance with features of one embodiment, in step 330, the UE establishes an HTTP/RTSP session with particular one of the 3PASes 124, as represented by an arrow 332. The UE receives from the 3PAS the QoS information, which may comprise one or more QoS attributes such as described above. In another embodiment of step 330, a wired UE 102c (as specified in FIG. 1) may receive the appropriate QoS information from the 3PAS. In step 340, the UE configures the QoS of the RAN 106 using conventional methods for the application signaling as well as the bearer data of the selected application, as represented by the arrow 342. In step 350, the UE activates the RAN QoS in accordance with the QoS information provided in step 330 for the selected application in a conventional fashion, as represented by the arrow 352. In step 360, the UE establishes the application session with the 3PAS that contains the appropriate QoS in the RAN/CN, as represented by the arrow 362.

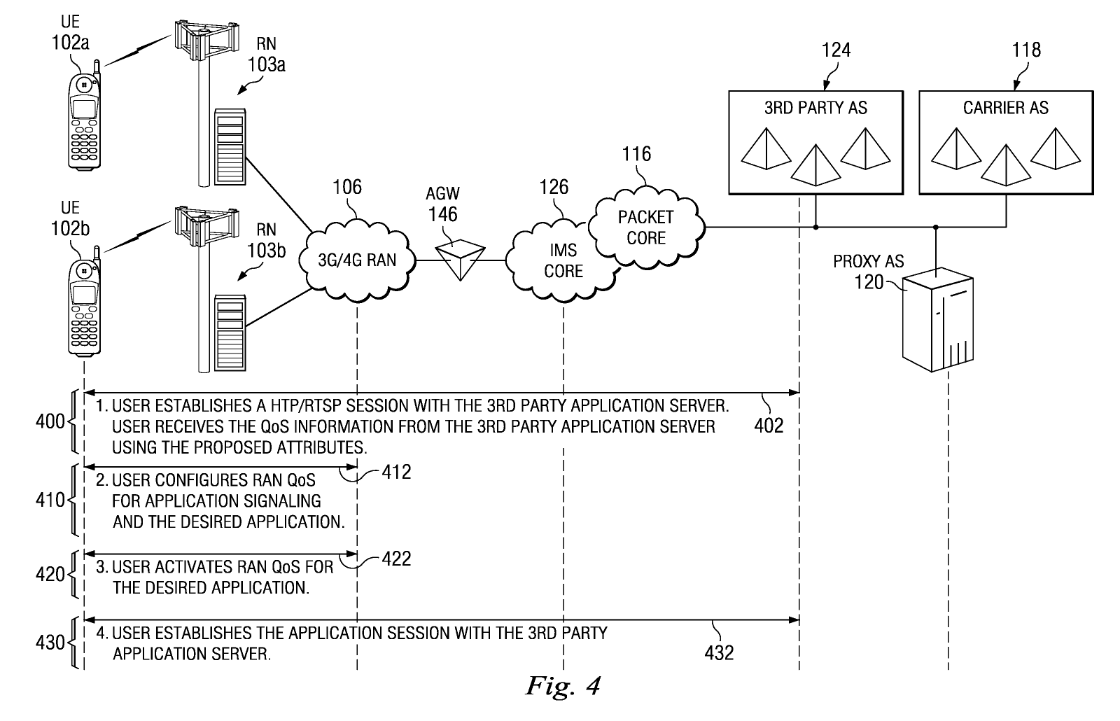

FIG. 4 illustrates a second exemplary call flow implemented using the wireline and/or wireless network 100. In step 400, in accordance with features of one embodiment, one of the UEs 102a, 102b, establishes an HTTP/RTSP session with a selected one of the 3PASes 124, as represented by an arrow 402. In this step, the UE receives from the 3PAS the QoS information, which may comprise one or more QoS attributes such as described above. In another embodiment of step 400, a wireline UE 102c (as shown in FIG. 1) may receive the appropriate QoS information from the 3PAS in the same manner. In step 410, the UE configures the RAN 106 QoS using conventional methods for the application signaling and the selected application, as represented by the arrow 412. In step 420, the UE activates the RAN QoS in accordance with the QoS information provided in step 400 for the selected application in a conventional fashion, as represented by the arrow 352. In step 430, the UE establishes the application session with the one of the 3PASes 124 that contains the appropriate QoS in the RAN/CN, as represented by the arrow 432.

It should be noted that the first and second call flow scenarios are similar; however, steps similar to steps 300, 310, and 320 of the first call flow are not needed in the second call flow; that is, the UE need not register with the PAS 120 and does not access the PAS to obtain the address of the 3PAS hosting the selected application. Instead, the UE accesses the host 3PAS directly and obtains therefrom the relevant QoS parameters. For this call flow to function properly, the provider of the wireline and/or wireless network 100 and the 3PAS provider must agree on the QoS parameters to be sent to the UE in step 400.

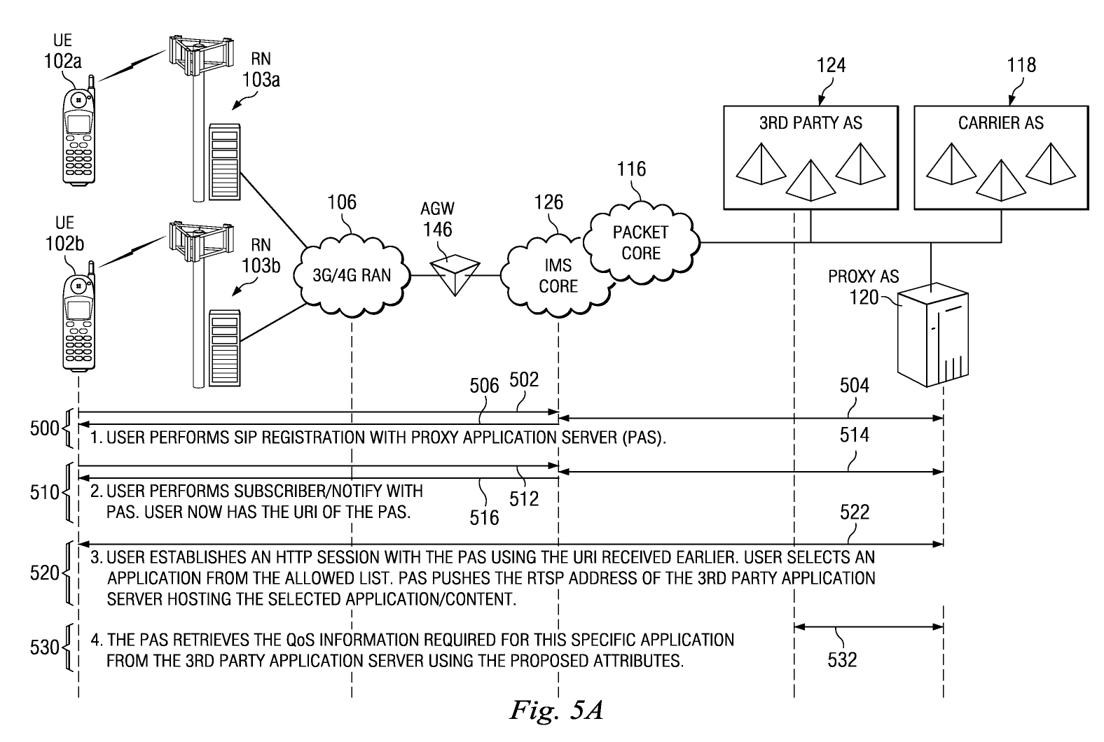

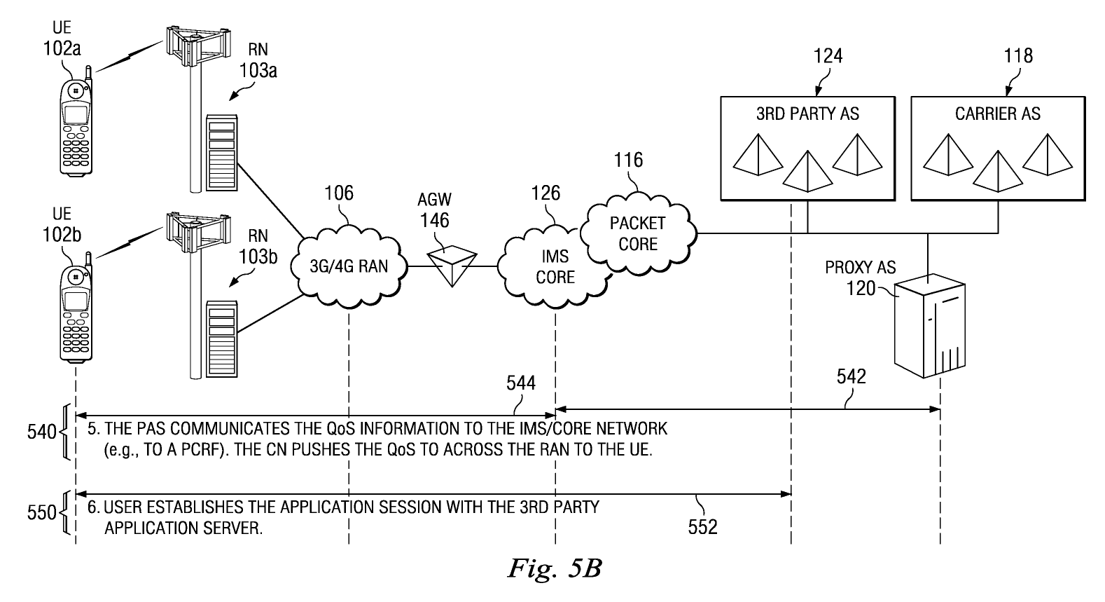

FIG. 5 illustrates a third exemplary call flow implemented using the wireline and/or wireless network 100. In step 500, one of the UEs 102a, 102b, performs an SIP registration with the PAS 120, as represented by arrows 502-506. In step 510, the UE performs a SUBSCRIBER/NOTIFY with the PAS 120, as represented by arrows 512-516. As a result of step 510, the UE has possession of the URI of the PAS 120. In step 520, the UE establishes an HTTP session with the PAS 120 using the URI received during step 510, as represented by an arrow 522. In this step, the UE is authenticated and provided a catalog of applications that the UE is authorized to access and from which the user may select. Once the user selects an application from the catalog, the PAS 120 pushes the address (such as RTSP, URI etc.) of the particular one of the 3PASes 124 hosting the selected application to the UE.

In accordance with features of one embodiment, in step 530, the PAS 120 retrieves from the 3PAS the QoS information required for the selected application, which may comprise one or more QoS attributes such as described above. In step 540, the PAS 120 communicates the received QoS information to the IMS/packet core networks 126, 116, as represented by an arrow 542. In particular, in step 540, the QoS information may be communicated to the PCRF (FIG. 1) of the core network 116. The core network pushes the QoS information across the RAN 106 to the UE, as represented by an arrow 544. In another embodiment of step 540, the PAS 120 may communicate the QoS information to the AGW 146 (FIG. 1) which in turn will push the QoS information across the RAN 106 to the UE. In yet another embodiment of step 540, a wireline UE 120c (as shown in FIG. 1) may receive the appropriate QoS information from the CN. In step 550, the UE establishes an HTTP/RTSP session with the 3PAS, as represented by an arrow 552.

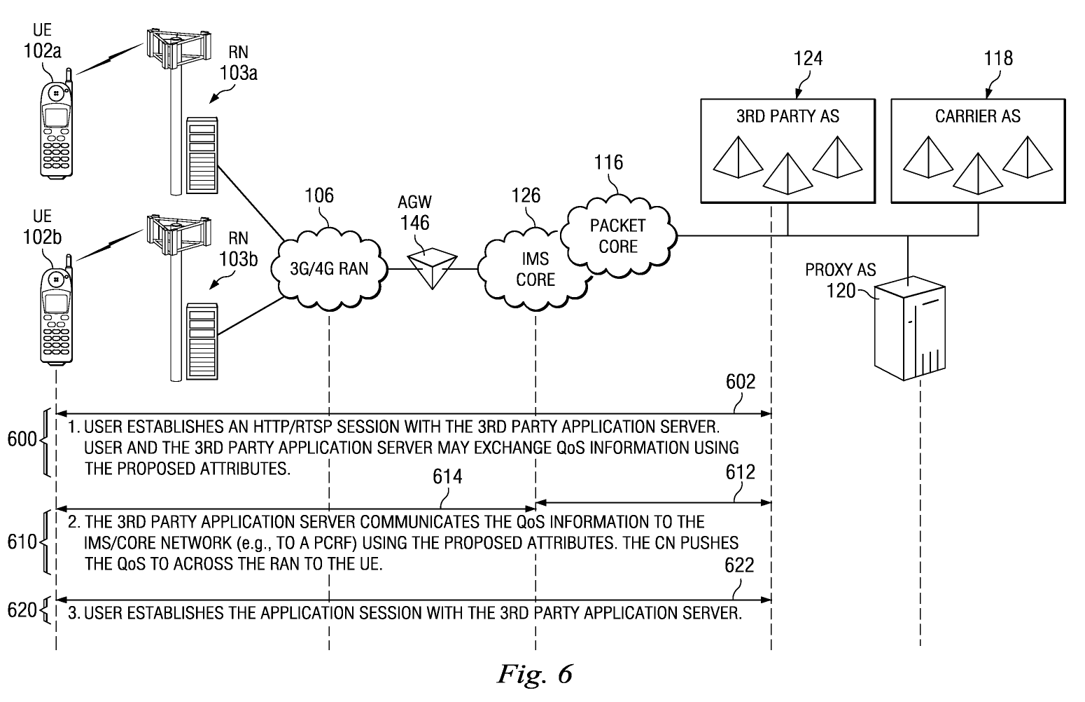

FIG. 6 illustrates a fourth exemplary call flow implemented using the wireless network 100. In step 600, one of the UEs 102a, 102b, establishes an HTTP/RTSP session with one of the 3PASes 124, as represented by an arrow 602. In this step, the UE and one of the 3PASes 124 may exchange the QoS information, which may comprise one or more QoS attributes such as described above. In step 610, the 3PAS communicates the QoS information to the IMS/packet core network 126, 116, as represented by an arrow 612. In particular, in step 610, the QoS information may be communicated to the PCRF 122 (FIG. 1). The CN 116 pushes the QoS information across the RAN 106 to the UE, as represented by an arrow 614. In another embodiment of step 610, the 3PAS may communicate the QoS information to the AGW 146 (FIG. 1) which in turn will push the QoS information across the RAN 106 to the UE. In yet another embodiment of step 610, a wireline UE 120c (as shown in FIG. 1) may receive the appropriate QoS information from the CN. In step 620, the UE establishes an HTTP/RTSP session with the 3PAS 124, as represented by an arrow 622.

While the figures above depict examples of enabling QoS over the wireless network, the same methods can also be applied to deliver QoS information to the wired UE 102c of FIG. 1.

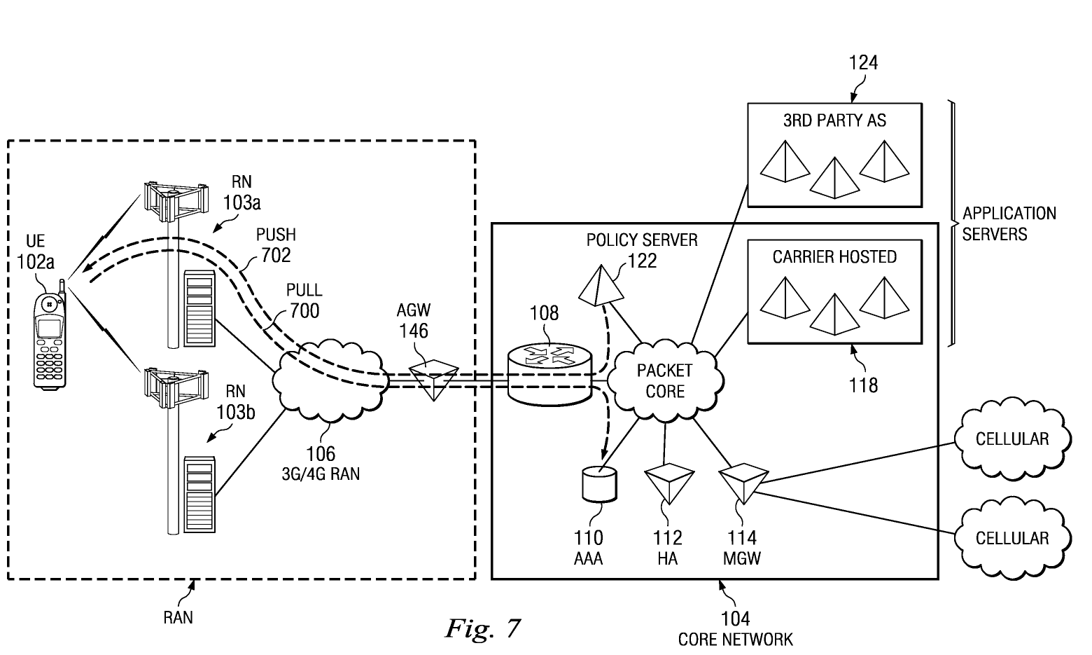

FIG. 7 illustrates a comparison of push and pull models of QoS information delivery using the wireless network 100. In particular, using the pull model, as represented in FIG. 7 by an arrow 700, QoS information delivery is initiated by a UE, such as the UE 102a, and validated by the network 100 based on the AAA 110 profile. Current DOrA implementation is based on a pull model. In contrast, most network operators prefer a push model, which is represented in FIG. 7 by an arrow 702. In the push model, QoS information is pushed from the PCRF 122 in the CN 104. 4G access technologies, such as WiMAX and LTE, have moved toward the push model. Push models have several advantages, including the fact that QoS can be user session-based as opposed to user profile-based, which reduces network management for delivering session-based applications. For example, privileged QoS can be provided to emergency responders; additionally, promotional applications can be marketed without changing the user profile. Still further, there is unified policy enforcement across the RAN and CN. For example higher/lower bandwidth per application based on time of day, user type, network utilization, etc., may be enforced. Moreover, the push model enables the interface with 3PAS vendors to be standardized, providing an opportunity to monetize popular applications, such as YouTube, MapQuest, etc. Finally, the push model enables seamless integration with the IMS network, providing a future-based implementation. The embodiments of the present disclosure supports both push and pull models.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method of providing quality of service (“QoS”) enablers for third party applications provided over a carrier network, the method comprising:
user equipment (“UE”) establishing a communications session with a third party application server hosting a selected third party application and receiving from the third party application server QoS information comprising at least one of a plurality of QoS attributes;
configuring a QoS of a radio access network (“RAN”) in accordance with the received QoS information;
activating the RAN QoS for the selected application; and
establishing an application session with the third party application server via the RAN.

2. The method of claim 1 further comprising, prior to the UE establishing a communications session:
the UE registering with a proxy application server (“PAS”) in accordance with a first protocol;
the UE obtaining a uniform resource identifier (“URI”) of the PAS; and
the UE establishing a communications session with the PAS using the received URI of the PAS.

3. The method of claim 1 wherein the communications session established by the UE with the third party application server comprises an HTTP/RTSP session.

4. The method of claim 2 wherein the first protocol comprises session initiation protocol (“SIP”).

5. The method of claim 3 wherein the UE obtaining the URI of the PAS comprises the UE performing a SUBSCRIBER/NOTIFY with the PAS.

6. The method of claim 2 wherein the communications session established by the UE with the PAS comprises an HTTP session.

7. The method of claim 1 wherein the plurality of QoS attributes comprise attributes selected from a group consisting of profile ID, QCI value, type of traffic, maximum rate, minimum rate, bucket size, token rate, emergency service indicator, audio codec type, video codec type, maximum latency, maximum packet loss rate, jitter sensitivity, emergency service indicator, and location coordinates.

8. A method of providing quality of service (“QoS”) enablers for third party applications provided over a carrier network, the method comprising:
user equipment (“UE”) registering with a proxy application server (“PAS”) in accordance with a first protocol;
the UE obtaining a uniform resource identifier (“URI”) of the PAS;
the UE establishing a communications session with the PAS using the received URI of the PAS and selecting an application hosted by a third party application server;
the PAS retrieving from the third party application server QoS information for the selected application, the QoS information comprising at least one of a plurality of QoS attributes;
communicating the QoS information to the UE; and
the UE establishing an application session with the third party application server via a radio access network (“RAN”).

9. The method of claim 8 wherein the communications session established by the UE with the third party application server comprises an HTTP/RTSP session.

10. The method of claim 9 wherein the first protocol comprises session initiation protocol (“SIP”).

11. The method of claim 10 wherein the UE obtaining the URI of the PAS comprises the UE performing a SUBSCRIBER/NOTIFY with the PAS.

12. The method of claim 8 wherein the communications session established by the UE with the PAS comprises an HTTP session.

13. The method of claim 8 wherein the communicating the QoS information to the UE further comprises:
the PAS communicating the QoS information to a core network; and
the core network pushing the QoS information to the UE via the RAN.

14. The method of claim 13 wherein the PAS communicating the QoS information to a core network comprises the PAS communicating the QoS information to a policy and charging rules function (“PCRF”) of the core network.

15. The method of claim 8 wherein the plurality of QoS attributes comprise attributes selected from a group consisting of profile ID, QCI value, type of traffic, maximum rate, minimum rate, bucket size, token rate, emergency service indicator, audio codec type, video codec type, maximum latency, maximum packet loss rate, jitter sensitivity, emergency service indicator, and location coordinates.

16. A method of providing quality of service (“QoS”) enablers for third party applications provided over a carrier network, the method comprising:
user equipment (“UE”) establishing a communications session with a third party application server hosting a selected third party application;
communicating the QoS information from the third party application server to a core network (“CN”) component such as policy and charging rules function (“PCRF”), the QoS information comprising at least one of a plurality of QoS attributes;
the CN component communicating that same QoS information to the UE, and
the UE establishing an application session with the third party application server via a radio access network (“RAN”).

17. The method of claim 16 wherein the communicating the QoS information from the third party application server to the UE further comprises:
the third party application server communicating the QoS information to a core network; and
the core network pushing the QoS information to the UE via the RAN.

18. The method of claim 17 wherein the third party application server communicating the QoS information to a core network comprises the third party application server communicating the QoS information to a policy and charging rules function (“PCRF”) of the core network.

19. The method of claim 16 wherein the communications session established by the UE with the third party application server comprises an HTTP/RTSP session.

20. The method of claim 16 wherein the plurality of QoS attributes comprise attributes selected from a group consisting of profile ID, type of traffic, maximum rate, minimum rate, bucket size, token rate, emergency service indicator, audio codec type, video codec type, maximum latency, maximum packet loss rate, jitter sensitivity, emergency service indicator, and location coordinates.
